(19) United States
(12) Patent Application Publication
(10) Pub. No.: US 2019/0105930 A1
(43) Pub. Date: Apr. 11, 2019

(54) IMAGE READING DEVICE AND INKJET RECORDING DEVICE

(71) Applicant: Konica Minolta, Inc., Tokyo (JP)

(72) Inventor: Masakazu DATE, Hino-shi, Tokyo (JP)

(21) Appl. No.: 16/086,887

(22) PCT Filed: Mar. 7, 2017
(86) PCT No.: PCT/JP2017/008911

§ 371 Date: Sep. 20, 2018

(30) Foreign Application Priority Data
Mar. 28, 2016 (JP) 2016-063742

(51) Int. Cl. B41J 29/393; H04N 1/40

(52) U.S. Cl. CPC B41J 29/393; H04N 1/40056

(57) ABSTRACT

Provided are: an image reading device which is capable of reading the surface of a recording medium easily and accurately, without being affected by irradiation light involved in the fixing of a recording image; and an inkjet recording device. This image reading device, which is provided in conjunction with an irradiation unit for irradiating a recording medium with electromagnetic waves of a prescribed wavelength for fixing discharged ink, and which is provided with a sensor for imaging the surface of the recording medium on which an image is formed by the ink that has landed thereon, is equipped with a blocking part for blocking entry, into the sensor, of the electromagnetic waves of the prescribed wavelength emitted by the irradiation unit.

### TECHNICAL FIELD

The present invention relates to an image reading device and an inkjet recording device.

### BACKGROUND ART

Conventionally, there has been an inkjet recording device which discharges an ink to the recording medium and forms an image by the discharge pattern of the ink. There are various kinds of ink used in the inkjet recording device, and there are a UV curing type ink which solidifies to be fixed when the ultraviolet ray (UV ray) is emitted, an ink which has the ink component fixed when the infrared ray (IR) is emitted and the water evaporates, and the like. The formed image can stably be maintained for a long period without deterioration, due to the use of these inks and emission of an electromagnetic wave with an appropriate wavelength to the formed image (for example, Patent Document 1).

Moreover, there is an image forming device which can perform calibration relating to the image recording operations and detect the failure of the image recording operations by reading the surface of the recording medium, especially, the image formed on the surface and the like. Generally, in the image forming device, the recording medium is supplied to the predetermined image recording position, and is ejected after the formation of the image. The reading section which reads the image is provided on the way of the conveyance path of the recording medium. As for the reading section, multiple image capturing elements arrayed one-dimensionally as a line sensor, or arrayed two-dimensionally as an area sensor is used favorably. In the event of reading a color image, each color of RGB is separated, or selected in order by a filter and input respectively to the different image capturing device.

### PRIOR ART DOCUMENT

### Patent Document

Patent Document 1: WO 2014/208588

### DISCLOSURE OF THE INVENTION

### Problems to be Solved by the Invention

However, when both irradiator and the image capturing sensor are provided, the electromagnetic wave of which wavelength that was emitted from the irradiator enters the sensor directly or indirectly such as by reflecting on the surface of the recording medium. The problem is that if the image capturing sensor includes the sensitivity on the frequency range of these incident waves, an offset of the incident wave from the image capturing sensor occurs with respect to the incident light quantity from the surface of the recording medium, which makes it difficult to accurately read the light quantity.

An object of the present invention is to provide an image reading device and an inkjet recording device which can read the surface of the recording medium without being effected by the irradiation light relating with the fixing of the recorded image.

### Means for Solving the Problem

In order to achieve the above object, the invention described in claim 1 is an image reading device which is provided together with an irradiator that emits an electromagnetic wave of a predetermined wavelength for fixing an ink discharged on a recording medium, and which has a sensor to perform image capturing of a surface of the recording medium on which an image is formed by the ink that has landed, the device including: a blocker which blocks incidence of the electromagnetic wave of the predetermined wavelength to the sensor.

The invention described in claim 2 is the image reading device according to claim 1, wherein the electromagnetic wave of the predetermined wavelength is an ultraviolet ray.

The invention described in claim 3 is the image reading device according to claim 1 or 2, wherein the sensor has a photoelectric convertor which light from an image capturing target range enters, the photoelectric convertor being provided on a surface of a substrate, and the photoelectric convertor is shut inside an optical path area which includes an incident window which light from the image capturing target range passes through.

The invention described in claim 4 is the image reading device according to claim 3, wherein the blocker is provided in the incident window.

The invention described in claim 5 is the image reading device according to claim 3 or 4, wherein an antifouling layer is provided on an outer surface of the incident window.

The invention described in claim 6 is the image reading device according to any one of claims 3 to 5, wherein a reflection prevention layer of visible light is provided in the incident window.

The invention described in claim 7 is the image reading device according to any one of claims 3 to 6, including an illuminator which is provided inside the optical path area and lights up the image capturing target range of the sensor through the incident window.

The invention described in claim 8 is the image reading device according to any one of claims 3 to 7, including a case body accommodating the optical path area and the substrate inside, wherein a heat dissipater to dissipate inner heat is provided in the case body.

The invention described in claim 9 is the image reading device according to claim 8, wherein the heat dissipater includes a ventilation fan, an opening where air outflows and inflows by the ventilation fan, and a filter which blocks outflow and inflow of a dust at the opening.

The invention described in claim 10 is the image reading device according to any one of claims 1 to 9, wherein the blocker attenuates an effect of the electromagnetic wave which the irradiator emits for 10 dB or more, with respect to a light receiving sensitivity of a predetermined detecting target wavelength range by the sensor.

The invention described in claim 11 is the image reading device according to any one of claims 1 to 10, wherein the sensor performs image capturing of the surface of the recording medium on which the ink that has landed on the recording medium is fixed by the irradiator.

The invention described in claim 12 is an inkjet recording device including; a recorder which discharges an ink onto a recording medium, the irradiator, and the image reading device according to any one of claims 1 to 11.

The invention described in claim 13 is the inkjet recording device according to claim 12, including a conveyer which conveys the recording medium, wherein an image capturing target range of the sensor is next to an emitting position of the irradiator in the downstream to the emitting position, with respect to a conveyance direction of the recording medium by the conveyer.

### Effects of the Invention

According to the present invention, reading the surface of the recording medium can easily and accurately be done without being effected by the irradiation light relating with the fixture of the recorded image.

### BRIEF DESCRIPTION OF DRAWINGS

FIG. 1 This is a schematic front view showing the configuration of the inkjet recording device including an image reader which is an embodiment of the image reading device of the present invention.

FIG. 2 This is a schematic diagram showing the inner configuration of the image reader seen from the front.

FIG. 3 This is a diagram showing an example of spectral sensitivity characteristic of the detector.

FIG. 4 This is a diagram showing the layer configuration of the covering member.

FIG. 5 This is a block diagram showing the functional configuration of the inkjet recording device.

FIG. 6 This is a schematic diagram showing the configuration of the modification example of the inkjet recording device.

### EMBODIMENTS FOR CARRYING OUT THE INVENTION

Hereinafter, an embodiment of the present invention will be described on the basis of the drawings.

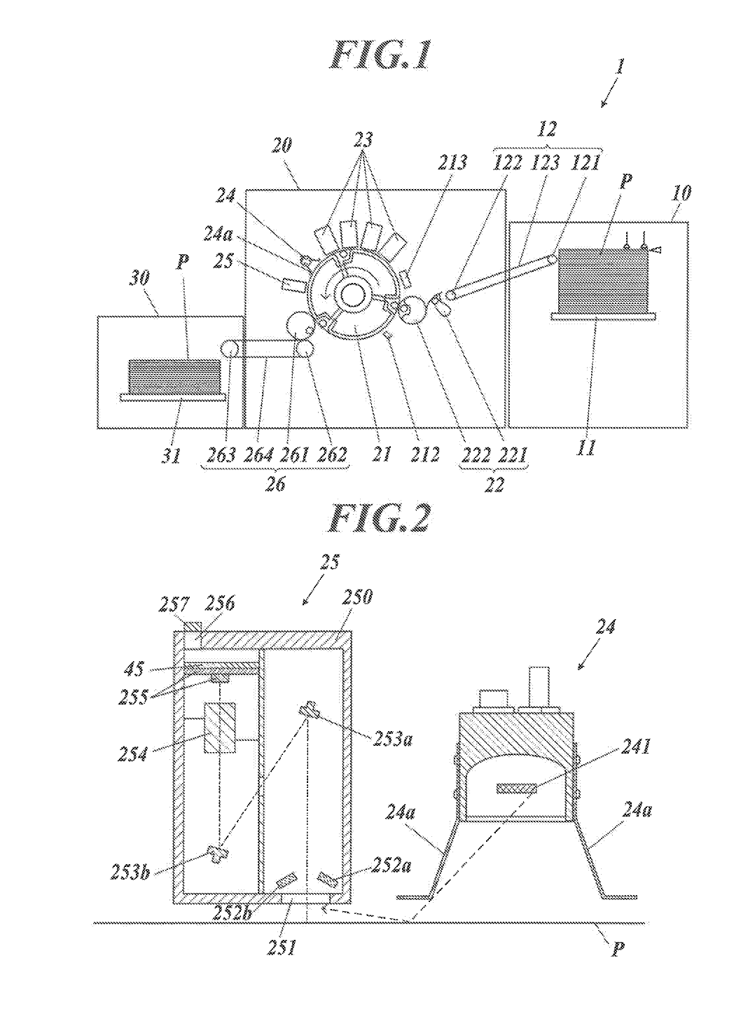

FIG. 1 is a schematic front view showing the configuration of the inkjet recording device including an image reader which is an embodiment of the image reading device of the present invention.

FIG. 1 indicates the inkjet recording device 1 when it is seen from the front.

The inkjet recording device 1 is a printer including a line head, which moves the recording medium towards the line head and discharges four inks at an appropriate timing to form a color image.

The inkjet recording device 1 includes a medium supplier 10, an image forming body section 20, a medium ejector 30, and a controller 40 (see FIG. 5) and the like. In this inkjet recording device 1, based on the control of the controller 40, the recording medium P stored in the medium supplier 10 is conveyed to the image forming body section 20 and ejected to the medium ejector 30 after the image is formed.

The medium supplier 10 carries the recording medium P stored inside to the image forming body section 20 one by one.

As for the recording medium P, various objects which may be curved and carried around the outer periphery surface of the image forming drum 21, such as printing paper of various thickness, cel, film, cloth and more are used.

The medium supplier 10 includes a paper feeding tray 11 which stores the recording medium P, a feeder board 12 which conveys the recording medium P from the paper feeding tray 11 to the image forming body section 20. The paper feeding tray 11 is a plate-like member which is made mountable for one or more recording medium P. The paper feeding tray 11 is provided to move vertically according to the amount of the recording medium P mounted on the paper feeding tray 11, and for the vertical move, the topmost of the recording medium P is kept in the position where it is able to be conveyed by the feeder board 12.

The feeder board 12 includes a conveyance mechanism which conveys the recording medium P on the belt 123 by driving the ring-shaped belt 123 carried inside by multiple (for example two) rollers 121, 122, and a supplier which delivers the topmost recording medium P mounted on the paper feeding tray 11 to the belt 123. The feeder board 12 conveys along the belt 123 the recording medium P which was delivered from the supplier to the belt 123.

The image forming body section 20 provides an image forming drum 21, a delivery unit 22, a head unit 23 (the recorder), an irradiator 24, an image reader 25, and a delivery section 26 and the like.

The image forming drum 21 has a cylindrical outward form which carries maximum of three pieces of the recording medium P on the outer periphery surface of the cylindrical section, and makes the conveying move to convey the recording medium P responding to the rotating operation done on the axis of the cylinder. Near the outer periphery surface of the image forming drum 21, a drum heater 213 which heats the outer periphery surface and the recording medium P, and a drum temperature measure 212 which measures the temperature of the outer periphery surface, are provided. In the embodiment, the drum heater 213 is provided between the delivery position of the recording medium P from the delivery unit 22 to the image forming drum 21 and the image recording position of the recording medium P by the head unit 23, with respect to the direction of the rotation of the image forming drum 21. Also, the drum temperature measure 212 is provided between where the recording medium P is delivered to the delivery section 26 and where the recording medium P is delivered from the delivery unit 22. The outer periphery surface of the image forming drum 21 is heated to make the carried recording medium P to be at an appropriate temperature by the drum heater 213 at the intensity corresponding to the measured temperature by the drum temperature measure 212. This keeps the appropriate hardening speed and the like of the ink on the recording medium P when the ink landed on the recording medium P, and a high quality image is stably formed. As for the drum heater 213, for example, the infrared ray heater is used.

The delivery unit 22 delivers the recording medium P delivered from the medium supplier 10 to the image forming drum 21. The delivery unit 22 includes a swing arm section 221 which carries an edge of the recording medium P conveyed by the feeder board 12, and a cylindrical delivery drum 222 and the like which delivers the recording medium P carried by the swing arm section 221 to the image forming drum 21, and by picking up the recording medium P on the feeder board 12 by the swing arm section 221, and delivering it to the delivery drum 222, it leads the recording medium P towards the direction along the outer periphery surface of the image forming drum 21, and delivers to the image forming drum 21.

The head unit 23 discharges an ink droplet at an appropriate timing from the multiple nozzle openings on the head unit 23 provided on the opposite surface (the nozzle face) to the recording targeted surface of the recording medium P, to a recording targeted surface of the recording medium P which moves responding to the rotation of the image forming drum 21, then an image is formed by making a landing on the recording targeted surface of the recording medium P. The head unit 23 includes one or more recording heads which provides multiple nozzles. According to the embodiment of the inkjet recording device 1, the head units 23 are located in a predetermined interval, in the direction of the conveyance of the recording medium P, and four are located here responding to each of the four inks. Each of the four head units 23 outputs the inks of C (cyan), M (magenta), Y (yellow), and K (black). These inks used here are those which hardens when the UV ray is emitted. Also, the inks are heated and kept at an appropriate temperature inside and/or outside the head unit 23 by the ink heater 233 (see FIG. 5).

In the embodiment, each head unit 23 includes the arraying multiple nozzle openings over the range of the image forming breadth of the recording medium P, in the breadth direction perpendicular to the conveyance direction of the recording medium P which is respectively conveyed on the image forming drum 21, and provides a line head which can form an image in a single-pass manner by discharging the ink from the nozzle openings to the recording medium P while moving the recording medium P in the direction of conveyance. The head unit 23 is installed on the supporter (carriage) abbreviated in the illustration.

The irradiator 24 emits an energy ray of a predetermined wavelength (electromagnetic wave), in the embodiment, which is an ultraviolet ray of the near-ultraviolet range (the wavelength is about 400 nm), and hardens and fixes the ink (that is, the imaged formed by the ink) which was discharged from the head unit 23 and landed on the recording medium P. For example, the irradiator 24 includes a light emitting diode 241 (LED, see FIG. 2) that emits an ultraviolet ray, and emits the ultraviolet ray by applying the voltage on the LED 241 to send an electrical current to emit light. The irradiator 24 is provided to be able to emit the ultraviolet ray on the recording medium P in the position where the recording medium P is not yet delivered to the delivery section 26 (irradiation position), after the ink was discharged from the head unit 23 to the recording medium P which is conveyed by the rotation of the image forming drum 21. In the irradiator 24, a shielding plate 24a is provided so as to cover the LED 241 and the settled range to decrease the leakage amount of the ultraviolet ray outside the settled range (irradiation position) which is for emitting the ultraviolet ray on the recording medium P.

Further, the configuration of the ultraviolet ray emission in the irradiator 24 is not limited to the LED. For example, the irradiator 24 could include a mercury lamp. Also, if the ink has a property of hardening by the emission of an energy ray besides the ultraviolet ray, instead of the configuration of the ultraviolet ray emission described above, a well-known light source which emits an energy ray of the wavelength to harden the ink, is provided.

The image reader 25 captures the surface of the recording medium, that is, an image formed on the recording medium P by the head unit 23 and fixed by the emission of the ultraviolet ray by the irradiator 24, in the position downstream the irradiator 24 with respect to the conveyance direction of the recording medium, in the embodiment, next to the emission position of the irradiator 24 and outputs the image captured data. The image reader 25 performs image capturing with the use of sensors such as the line sensor and the area sensor as an image capture section. The image reader 25 is described below.

The delivery section 26 conveys the recording medium P to the medium ejector 30 after the image forming finishes and the landed ink hardens. The delivery section 26 includes a cylindrical delivery roller 261 and multiple (for example, two) rollers 262, 263 and a ring-shaped belt 264 and the like which is supported inside by the rollers 262 and 263. The delivery roller 261 leads the recording medium P delivered from the image forming drum 21 to the belt 264. The delivery section 26 sends the recording medium P delivered from the delivery roller 261 to the belt 264, by moving together with the belt 264 which moves circulatory involving with the rotation of the rollers 262, 263 and conveys the recording medium P to the medium ejector 30.

The medium ejector 30 stores the recording medium P sent from the image forming body section 20 by the delivery section 26 until the user takes out. The medium ejector 30 includes a plate-like paper output tray 31 and the like, and mounts on this paper output tray 31 the recording medium P on which the image is formed.

The controller 40 controls the operation of the medium supplier 10, the image forming body section 20, and the medium ejector 30, which forms an image on the recording medium P according to the settings for the data of the formation targeted image and the image formation by the image forming command (job).

Among the above-mentioned configuration, the conveyer is configured by the medium supplier 10 and the image forming drum 21, the delivery unit 22, and the delivery section 26 among the image forming body section 20, and the medium ejector 30.

Next, the image reader 25 will be described.

FIG. 2 is a schematic diagram showing the inner configuration of the image reader 25 seen from the front.

In the embodiment, the lower side of the figure indicates the mounting surface of the recording medium P and the image forming drum 21 in the FIG. 1. Further in the embodiment, it also indicates that the irradiator 24 is located next to this image reader 25.

The image reader 25 provides a light source 252a, 252b (together also written as the illuminator 252), mirror 253a, 253b, optical lens section 254, the detector 255 which includes the above-mentioned sensor, the reading driving controller 45 and the like, accommodates them inside the case body 250. In a part of the case body 250, an incident window which the light from the outside enters through the cover member 251, is provided. The case body 250 is provided in the position and the direction, which the surface where the incident window is provided (incidence face) faces the outer periphery surface of the image forming drum 21, that is, the surface of the conveyed recording medium P. Also the case body 250 provides a ventilation opening 256 (an opening) which is a heat dissipater that outflows and inflows the air to air-cool the reading driving controller 45 and the detector 255, and a ventilation fan 257 on the face opposite to the incident window. The ventilation opening 256 provides a filter so the ink mist, the dust, and the like rubbish would not outflow or inflow. In the case body 250, each component is settled by the settlement member abbreviated in the figure, also, the optical path (optical path area) from the incident window to the light receiving element of the detector 255 is separated from the operating portion such as the reading driving controller 45 and the ventilation opening 256 by the substrate and the partition member at least constitutionally so that the outer light does not intrude into except from the incident window, and furthermore, it is desirable to be shut.

The light source 252a, 252b lights up the reading range (image capturing target range) of the recording medium P. The light source 252a, 252b is provided near the cover member 251 where it would not hinder the optical path (the route of the incident light) from the reading surface to the detector 255. As for the light source 252a, 252b various types can be used such as the LED (Light Emitting Diode), and the organic light-emitting diode. The luminance of these light sources 252a, 252b can, for example, be configured suitably to be changeable by predetermined number of steps.

The mirror 253a, 253b reflects the light entered from the incident opening by penetrating the cover member 251, and leads to the optical lens section 254. In the embodiment, the mirror 253a, 253b is a plane mirror, however a concave mirror which condenses light in at least one direction according to the need, can be used.

The optical lens section 254 includes a lens which reduction imaging of the light from the desired reading position entered through the incident window in the position of the detector 255, and a filter (BPF and LPF) which respectively selects and passes the light with each wavelength of RGB. The filter used here does not completely shut out the light whose wavelength is not selected under the strictly prescribed boundaries between the visible ray and the IR and the UV.

The detector 255 includes an image capturing element which detects the charge amount or the voltage value corresponding to the charge amount earned by the light receiving element (the photoelectric convertor) that converts the incident light condensed by the optical lens section 254 to the electric charge according to the light quantity. As for the image capturing element, for example, CCD (Charged Coupled Device) sensor and CMOS (Complementary Metal Oxide Semiconductor) sensor are used. In the embodiment, the line sensor in which the image capturing elements are arrayed so that one-dimensional image capturing is possible in the range of the recording available breadth, respectively in the breadth direction relating with each of the light with the wavelength of RGB, is provided. As for the light receiving element, for example, the photocoupler and the photo diode are used. The image capturing element is formed on the substrate, and the light receiving element is provided on a surface of the substrate.

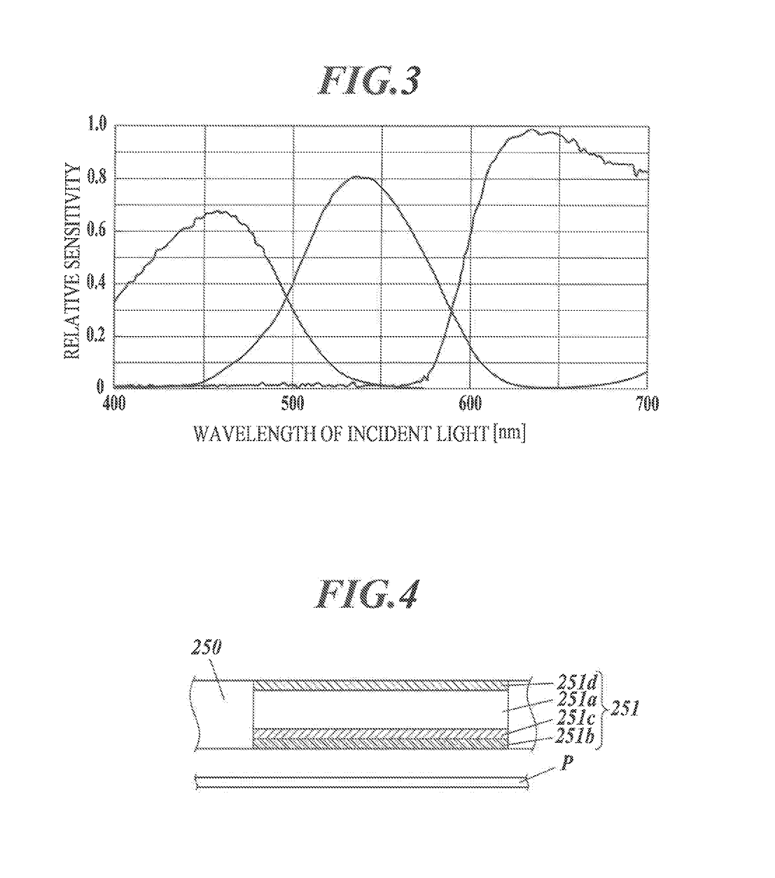

FIG. 3 is a diagram showing an example of spectral sensitivity characteristic by the detector 255.

In the embodiment, the relative sensitivity of the image capturing element which detects the wavelength range of the each color of RGB is indicated, and respectively has the peak near 630 nm, 540 nm, and 460 nm and detects light of each wavelength approximately complementary. Further, the image capturing element having the sensitivity in the range of the red color wavelength has the sensitivity up to the range of infrared radiation, which is more than 700 nm (800 nm), and the image capturing element which has the sensitivity in the range of the blue color wavelength has the sensitivity down to the range of ultraviolet ray, which is less than 400 mm. Therefore, the near-ultraviolet ray which the above-mentioned irradiator 24 emits is included in the detection range.

The cover member 251 is a transparent member which is located on the incident window facing the outer periphery surface of the image forming drum 21, and prevents the intrusion of the ink mist and the dust inside the case body 250 as well as passing through and allowing entering of the light (incident light) according to the test image from the recording medium P (the reading surface) carried by the image forming drum 21. As for the cover member 251, a well-known transparent member (for example, a glass plate) which penetrates the visible rays are used.

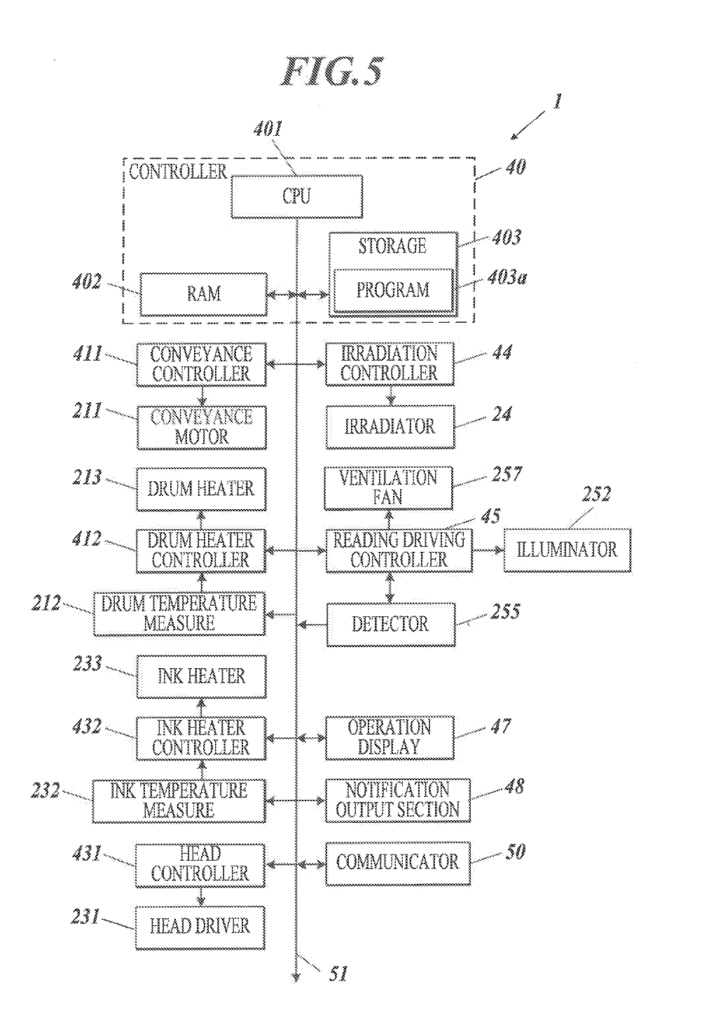

FIG. 4 is a diagram showing the layer configuration of the cover member 251.

The cover member 251 is provided with a UV cut layer 251c (the blocker) on the outer side of the case body 250 with respect to the transparent member 251a, that is on the opposing side of the recording medium P, and also on the outer side of the UV cut layer 251c (the opposing side of the transparent member 251a), that is, the outside surface of the incident window, the antifoul coating 251b (the antifouling layer) is further made. Moreover, inside the case body 250, that is, on the facing side of the light source 252a, 252b, the AR coating layer 251d (reflecting prevention layer) used for the prevention of the reflection of the visible ray is provided.

The UV cut layer 251c selects and prevents (blocks) the UV light entering from the outside to the inside of the case body 250. The UV cut layer 251c blocks the electromagnetic wave which is on the short-wavelength side than the near-ultraviolet range. As illustrated in above-mentioned FIG. 2 and the like, most of the ultraviolet light emitted by the irradiator 24 which is located next to the image reader 25 is blocked by the shielding plate 24a, however, due to the UV light and the like, which was reflected by the recording medium P, leaking from a gap between the recording medium P and the shielding plate 24a and attaining to the image reader 25 (the broken line in FIG. 2), it enters inside the case body 250 from the incident window in the image reader 25, and gets incorrectly detected by the image capturing element (CCD sensor) which has the sensitivity mainly in the range of the blue color wavelength. By providing a UV cut layer 251c on top of the transparent member 251a of the incident window, it prevents the entering and the detection of the UV light easily and surely than adjusting finely the detection wavelength range of the CCD sensor. The UV cut layer 251c is formed by layering or by coating on the transparent member 251a, or, is configured by installing another filter besides the transparent member 251a. Or, the component of the UV cutting may be mixed in the transparent member 251a. The UV cut layer 251c is desirable to at least attenuate the effect by 10 dB or more, the effect being made on light receiving sensitivity of the entire detected wavelength by the detector 255 (here, a sensor which detects the wavelength range of the light corresponding mainly to the blue color) when the ultraviolet ray emitted by the irradiator 24 enters inside the case body 250. That is, even if the entering of the ultraviolet ray inside the body case 250 is not completely blocked, it is sufficient that the light receiving sensitivity of the ultraviolet ray wavelength by the image reader 25 falls enough with respect to the light receiving sensitivity of the visible light wavelength (the blue color wavelength range for the image capturing element which detects the blue color).

The antifoul coating 251b prevents the occurrence of the abnormal reading due to the disturbance to the incident light for inside the body case 250 by the adherence of the dust and the rubbish on the incident window, or, the damage to the surface of the UV cut layer 251c and the transparent member 251a by the dust and the rubbish. The antifoul coating 251b could only be with the function of dust proofing, or could be more high-functioned.

The AR coating layer 251d prevents the entrance of the light emitted from the light source 252a, 252b to the optical lens section 254 by being reflected on the transparent member 251a and the UV cut layer 251c and the like. Also, when the reflection of the recording medium P is strong, for example on the white part of the glossy paper, potion of the light reflected on the recording medium P is reflected by the cover member 251 and emitted to the recording medium P, and thereby the effect of the flare effect which increases the detected light quantity of the emitted range could be held down. The number of layers of the AR coating layer 251d, and the material and the thickness of each layer would be decided appropriately.

FIG. 5 is a block diagram showing the functional configuration of the inkjet recording device 1 of the embodiment.

The inkjet recording device 1 provides the above-mentioned controller 40, the conveyance controller 411 and the conveyance motor 211, the drum heater controller 412, the drum heater 213 and the drum temperature measure 212, the ink heater controller 432, the ink heater 233 and the ink temperature measure 232, the head controller 431 and the head driver 231, the irradiation controller 44 and the irradiator 24, the reading drive controller 45, the illuminator 252, detector 255 and the ventilation fan 257, the operation display 47, the notification output section 48, the communicator 50, and the bus 51 which connects between each component to transmit the data.

The controller 40 includes the CPU 401, the RAM 402, the storage 403, and the like. The controller 40 temporary stores in the RAM 402 the program 403a for controlling and the setting data read from the storage 403, and the CPU 401 performs a control processing based on the temporary stored data. The storage 403 includes the assistant storage such as the non-volatile memory, the HDD and the like which is readable and writable. In a part of the storage 403, the ROM could be used.

The controller 40 (CPU 401) integrally controls the operation of the inkjet recording device 1. The controller 40 respectively operates the medium supplier 10, the image forming body section 20, and the medium ejector 30 at an appropriate timing based on the order relating to the image forming and the formed image data acquired externally through the communicator 50, which is the print job, and forms an image on the recording medium P.

The operation display 47 displays a display which accepts the operation by the user, and shows the user the status information and the operation menu and the like. For the operation display 47, the display screen made by the tier of the touch sensor, for example the LCD (liquid crystal display) are provided and used, and together with displaying various kinds of the menu and the status and the like relating to the image forming on the LCD display screen, it is able to detect the touch manipulation with respect to the indication of the display screen.

The notification output section 48 performs a predetermined notification operation when an abnormality occurs on the inkjet recording device 1. As for the notification output section 48, for example, a sound generator which generates a predetermined beeping noise with the use of the piezoelectric element and the like, and an emitter which switches on and off or turns on the LED lamp could be given.

The communicator 50 is an interface which performs communication connection with the external device such as PC, and performs data communication according to the standard. As for the communicator 50, for example, the network card for the LAN connection could be given, besides, it could be a wireless communication interface using the Bluetooth connecting (registered trademark: Bluetooth), a connection terminal relating with the direct connection with the external device by the USB or the driver. The controller 40 acquires the print job and the control setting data and the like of the inkjet recording device 1 from the external device through the communicator 50.

The conveyance motor 211 operates each component of the image forming drum 21 and the like in a predetermined rotating speed by the control of the conveyance controller 411. The conveyance controller 411, for example, controls appropriately the rotating speed and the rotating position of each component such as the image forming drum 21, based on the rotating speed and the rotating angle position of the image forming drum 21 and the like acquired by the encoder abbreviated in the illustration. The conveyance controller 411 operates the control relating to the delivery of the recording medium P from the medium supplier 10 to the image forming body section 20, and the delivery from the image forming body section 20 to the medium ejector 30. Also, when an abnormality occurs among the conveyance of the recording medium P, the conveyance controller 411 promptly stops the operation of the conveyance motor 211 and stops the rotation of the image forming drum 21.

The drum heater 213 heats the outer periphery surface of the image forming drum 21 to an appropriate temperature as mentioned above. The temperature of the outer periphery surface of the image forming drum 21 is measured by the drum temperature measure 212, and based on the data measured by the drum temperature measure 212, the drum heater controller 412 suitably turns on and off the operation of the drum heater 213 to keep the temperature of the outer periphery surface of the image forming drum 21 in the range of the appropriate temperature. This enables the recording medium P to be at least settled in the appropriate range of temperature in the event of discharging the ink, and also suppresses the temperature change after ink discharging.

As for the drum heater 213, for example, a halogen lamp which emits the radiant heat is used, and the drum heater controller 412 sends an appropriate electrical currency to the halogen lamp. The radiant heat directly heats the outer periphery surface of the image forming drum 21, and also heats the outer periphery surface more effectively by reflecting with the reflecting plate abbreviated in the illustration.

The ink heater 233 heats the ink to an appropriate temperature inside and/or outside the head unit 23 in advance to the discharge of the ink. The temperature of the ink is measured by the ink temperature measure 232, and based on the measured data, the ink heater controller 432 suitably turns on and off the ink heater 233, and keeps the temperature of the ink in the predetermined range of the temperature by controlling the current quantity. For the ink heater 233, for example, some which occurs the joule heat due to the conduct such as the heating wire and the heating plate, are used.

The head driver 231 supplies the electricity to the load of the nozzle of the each head unit 23 (the piezoelectric element of the piezoelectric inkjet recording device and the heating element of the thermal inkjet recording device) according to the control signal and the input image data of the forming target sent from the head controller 431, and discharges the ink at an appropriate timing from the opening of the each nozzle.

The irradiation controller 44 operates to emit the energy ray (ultraviolet ray) from the irradiator 24 to the recording medium P on which the image is formed according to the operation of the head driver 231. The irradiation controller 44 may either make emit continuously from the beginning of the image forming of the first recording medium P to the end of the image forming of the last recording medium P while the chain of image recording operation is done, for example, when the image recording operation is done for multiple recording medium P in continuation, or may control the turning on and off of the emission of the ultraviolet ray while the recording medium P passes through the emission range of the ultraviolet ray by the irradiator 24. Or, it could be the moderate of these.

The reading driving controller 45 operates the detector 255 in the state which the illuminator 252 (the light source 252a, 252b) is turned on. The reading driving controller 45 makes the detector 255 detect, for each wavelength range of the RGB, the incident light from the predetermined range of the recording medium P facing the cover member 251, that is, mainly the reflection light from the irradiation light by the light source 252a, 252b, and makes the detector 255 convert the detected data to the color value of each color of RGB and output the converted data to the CPU 401.

Also, the reading driving controller 45 makes the detector 255 perform a detection operation of the image on the recording medium P in a cycle corresponding to the conveyance speed of the recording medium P in the timing when the recording medium P passes through the image reading range of an image of the image reader 25. The reading driving controller 45 suitably operates the ventilation fan 257 to dissipate the heat occurred inside the body case 250 due to the operation of the reading driving controller 45 and the detector 255.

Further, in the above mentioned embodiment, the conveyance controller 411, the drum heater controller 412, the ink heater controller 432, the irradiation controller 44, the reading driving controller 45 and the head controller 431 are respectively indicated apart from the controller 40, however, everything could be configured to perform the control operation by the common CPU 401, the RAM 402 and the like.

### MODIFICATION EXAMPLE

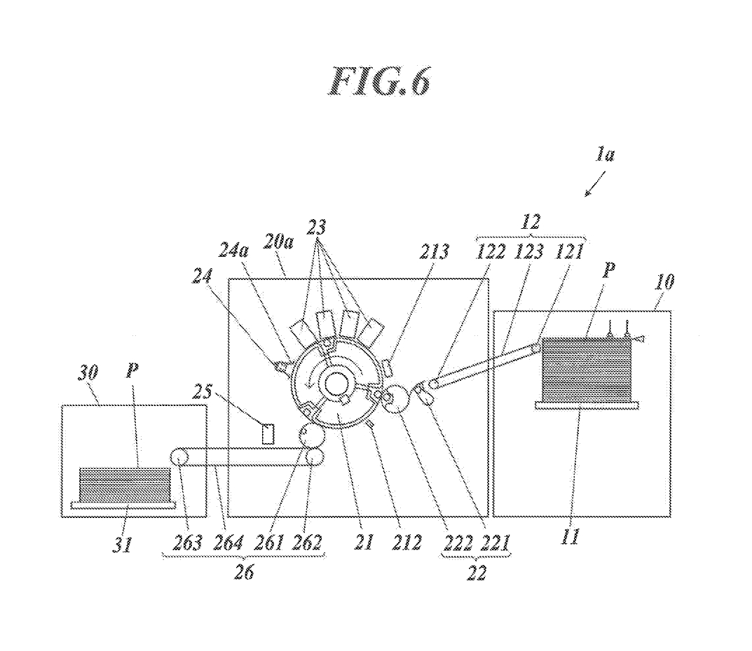

FIG. 6 is a schematic diagram showing the configuration of the modification example of the inkjet recording device 1.

The inkjet recording device 1a of the modification example is as same as the above-mentioned embodiment of the inkjet recording device 1 and for the same configuration, except for the point where the incident surface of the image reader 25 is provided facing the belt 264, and the surface of the recording medium P on the belt 264 is captured in the image forming body section 20a, and thus the same reference number is given and the description is abbreviated.

As shown in the modification example, the irradiated UV light from the irradiator 24 would enter into the detector 255 of the image reader 25 despite the irradiator 24 and the image reader 25 are not necessarily located next to each other on the same conveyance surface, especially, it might be a relative position relation which could more easily make the UV light incident, and also in this occasion, by providing the UV cut layer 251c on the cover member 251 of the incident window of the image reader 25, the detection error of the incidence made and the light quantity due to the incidence made by the UV light to the detector 255 could certainly be prevented.

As mentioned above, the image reader 25 provided in the inkjet recording device 1 in the embodiment is provided together with the irradiator 24 which emits the UV light that fixes the ink discharged on the recording medium P, and includes a sensor (the detector 255) which image captures the surface of the recording medium P where the image is formed by the landed ink, and provides the UV cut layer 251c which blocks the incidence of the UV light into the detector 255 (the light receiving element).

Therefore, even when the irradiator 24 and the image reader 25 are both provided inside the same case body, an incidence of the UV light which would obstruct the normal reading of the sensor of the image reader 25 will not be made, and for the conventional sensor, it easily prevents the acquaintance of the incorrect captured image due to the mixture of the UV light into the wavelength detection range especially in the sensor that detects the blue color. Therefore, it is easily and accurately able to read the surface of the recording medium P, especially the recorded and the fixed image without being effected by the UV light relating to the fixture of the recording image.

The electromagnetic wave of the predetermined wavelength would be able to solidly fix the UV hardening ink by the UV light and to capture the image accurately at the same time with the use of the ultraviolet ray.

Also, the sensor of the detector 255 includes a photoelectric element which is provided on one surface of the substrate and the light enters from the image capturing target range, and the photoelectric element is shut inside the optical path area which includes the incident window where the light from the image capturing target range passes through. Therefore, unnecessary light from other than the incident window, especially the UV light which is made incidence into the photoelectric element is prevented, so as for the accurate reading of the image is possible. Moreover, by making it under a shut state, the entrance of the ink mist, the dust, and the like rubbish into the path of the incident light and the diffusion or the absorption of the incident light, which makes the detection of the light quantity inaccurate, would be prevented.

Also, the UV cut layer 251c is provided in the transparent member 251a of the incident window. Therefore, adding the structure relating with the UV cut to the conventional structure would easily be done. First of all, the UV light would not intrude into the optical path area, so it is able to prevent the unexpected change of the detection of the light quantity by the diffuse light and the like, inside.

On the outer surface of the incident window, the layer of the antifoul coating 251c is provided.

Therefore, it prevents the adherence of the dust and the like on the incident window which obstructs or diffuses the incident light that makes the detection of the light quantity inaccurate, and would be able to acquire the image captured data with the appropriate brightness distribution.

On the incident window, the AR coating layer 251d of the visible light is provided. This prevents the reading of the incorrect light quantity by the outer light, especially the light emitted from the light source 252a, 252b provided inside the case body 250 which reflects at the same phase so as to strengthen each other.

There is also included the illuminator 252 that lights up the image capturing target range of the sensor through the incident window, which is provided inside the optical path area. As the illuminator 252 is provided inside the case body 250, it is able to acquire the image captured data under a definite situation which steadily lights up the image capturing target range by an appropriate light quantity as configured compactly.

There is also provided a case body 250 which accommodates the optical path area and the substrate inside, and on the case body 250, the ventilation fan 257 which is a heat dissipater that dissipates the heat inside and the opening section 256 are provided.

This heat dissipater appropriately dissipates outside the heat occurred by the operation of the detector 255, the reading driving controller 45, and the like, and makes it possible to keep the steady operation and the image capturing efficiency.

Also the heat dissipater includes the ventilation fan 257, the opening 256 which the air by the ventilation fan 257 outflows and inflows, and the filter which blocks the outflow and the inflow of the dust at the opening 256. By cooling while trying not to give an effect to the optical path area inside the case body 250 in such a way, it is able to dissipate the heat easily and efficiently. Also, the filter is provided so as the outflow and the inflow of the ink mist and the dust does not occur from the opening 256, therefore, the trouble such as the coverage of the substrate circuit and the like by the dust, and the shortening among the circuits could be prevented.

Also the UV cut layer 255c attenuates the light receiving sensitivity of the image reader 25 for the UV light emitted from the irradiator 24, by 10 dB or more. In the detection of the blue color whose density is generally used in in the inspection without a perfect blocking of the UV light, by lowering the light receiving sensitivity of the UV light for more than an order degree, the detecting quantity of the UV light is sufficiently lowered compared to the detecting quantity of the blue color light, an effect which causes troubles in the reading is not generated, and therefore, an oversupply of the configuration is not needed, and it is possible to acquire the necessary effect at an appropriate cost.

The detector 255 captures the surface of the recording medium P which the ink lands on and the irradiator 24 fixes. In the embodiment of the inkjet recording device 1, even if the reading operation is done in the detector 255 of the image reader 25 while or right after the fixing operation, it does not make the incidence of the UV light into the detector 255 so as to occur the abnormal reading, therefore, it is able to read the recorded image formed easily and steadily, and together, for such steady reading of the recorded image, the irradiator 24 and the image reader 25 has no need to be separated widely so as to lengthen the conveyance path, or the irradiator 24 and the image reader 25 has no need to be prepared with a case body accommodating each separately, that is, it could be able to avoid increase in the size and the complication.

In the embodiment of the inkjet recording device 1, the head unit 23 which discharges the ink on the recording medium P, the irradiator 24 and the image reader 25 are provided. Therefore, in the inkjet recording device 1 that uses the ink which needs emission of the UV light by the irradiator 24, it is able to acquire the image captured data of the image on the recording medium P which is formed by the image reader 25 easily and with an appropriate image quality in a unified manner, and to use for every kind of adjustment, examination, and the like.

Also, the medium supplier 10 which is a conveyer conveying the recording medium, the delivery unit 22, the image forming drum 21, the delivery section 26 and the medium ejector 30 are provided, and the image capturing target range of the detector 255 (the sensor) is next to each other with the irradiating position on the downstream side of the irradiating position of the irradiator 24 with respect to the conveyance direction of the recording medium P by the conveyer.

Even when the irradiator 24 which relates with the fixing of the ink and the detector 25 are located next to each other, no baneful influence is given to the image captured data by the detector 255 in the configure relating to the present invention, therefore, there is no need for lengthening the conveyance length of the recording medium P, and it is able to reduce the number of the conveyance motor and the operating power, and to make the size of the inkjet recording device 1 more compact.

The present invention is not limited to the above-mentioned embodiments, but various changes could be made.

For example, in the above-mentioned embodiment, the example given and described was of when the cutting of the incidence made by the UV light into the detector 255 is performed, however, if other electromagnetic wave with the wavelength out of visible light, for example, the infrared ray is used for fixing the ink, the layer (the IR cut layer) which cuts the incidence made by the electromagnetic wave of the concerned wavelength (the IR light) could be provided on the incident window. Even if it was the visible light, when the electromagnetic wave wavelength used for the recording of the image and the wavelength used for the fixing do not overlap, or if they overlap but do not occur trouble on the reading operation even when the light whose electromagnetic wave wavelength is for fixing is cut for the white and black density image or the like, the present invention can be applied.

In the above-mentioned embodiment, the UV cut layer 251c would be provided on the incident window for the outer light into the case body 250, however, it is able to provide in the arbitrary position on the incident route of the light which is from the incident window to before the detector 255. For example, providing the UV cut filter before the optical lens section 254, and blocking the incidence made by the UV light to the optical lens section 254 is possible.

In the above-mentioned embodiment, the antifoul coating 251b and the AR coating layer 251d are provided, however, it is not necessary.

Also, the image reader 25 does not need to provide the light source 252a, 252b if it is able to light up the image capturing target range with appropriate and stable light quantity from outside.

Also, it is able to suitably settle the incident route of the outer light from the incident window to the detector 255. The number of times of the reflection by the mirror is not limited to two times, and the reflection direction and the like can be settled suitably. Also, the prism and the other optical lens system could be provided inside.

In the above-mentioned embodiment, the example given and described provided the ventilation opening 256 for heat dissipation and the ventilation fan 257, however, if the temperature inside does not raise so as to occur a trouble, the inside of the case body 250 could completely be shut without providing these.

In the above-mentioned embodiment, the example given and described was which the cut paper was used for the recording medium, supplied to the image forming drum 21, and each operation for recording, fixing, and reading the image was made, however, the continuous form paper such as the rolled paper and the long size cloth could be used, and the conveyer adopting the endless belt which conveys the recording medium on the plane surface instead of the image forming drum 1 could be provided.

The positional relation between the irradiator 24 and the image reader 25 is not limited to those indicated in the embodiment and the modification example. The present invention could be applied in the inkjet recording device having arbitrary locations where the incidence may be made by the electromagnetic wave such as ultraviolet ray emitted from the irradiator 24 to the image reader 25. For example, after the recording medium P, for which image formation was performed on the first endless belt, is delivered to the second endless belt, the emission of the ultraviolet ray and the reading of the image could continuously be done to the recording medium P on the second endless belt. That is, the configuration relating to the image recording, and the configuration relating to the fixing and the reading of the image could be different. Also, the recording medium P, for which the ink is not fixed, could be read by the image reader 25, and image capturing of the recording medium P surface could be done without the image forming (the landing of the ink). The image reader 25 which is provided on the upstream of the irradiator 24 with respect to the conveyance direction of the recording medium P is also included in the present invention.

The other specific details such as the configurations, arrangements and materials shown in the embodiments can be appropriately modified within the scope of the present invention.

### INDUSTRIAL APPLICABILITY

The present invention is applicable to the image reading device and the inkjet recording device.

### EXPLANATION OF REFERENCE NUMERALS

1, 1a inkjet recording device
10 medium supplier
11 paper feeding tray
12 feeder board
121, 122 roller
123 belt
20, 20a image forming body section
21 image forming drum
211 conveyance motor
212 drum temperature measure
213 drum heater
22 delivery unit
221 swing arm section
222 delivery drum
23 head unit
231 head driver
232 ink temperature measurement section
233 ink heater
24 irradiator
241 LED
24a shielding plate
25 image reader
250 case body
251 cover member
251a transparent member
251b antifoul coating
251c UV cut layer
251d AR coating layer
252 illuminator
252a, 252b light source
253a, 253b mirror
254 optical lens section
255 detector
256 ventilation opening
257 ventilation fan
26 delivery section
261 delivery roller
262, 263 roller
264 belt
30 medium ejector
31 paper output tray
40 controller
401 CPU
402 RAM
403 storage
403a program
411 conveyance controller
412 drum heater controller
431 head controller
432 ink heater controller
44 irradiation controller
45 reading driving controller
47 operation display
48 notification output section
50 communicator
51 bus
P recording medium

1. An image reading device which is provided together with an irradiator that emits an electromagnetic wave of a predetermined wavelength for fixing an ink discharged on a recording medium, and which has a sensor to perform image capturing of a surface of the recording medium on which an image is formed by the ink that has landed, the device comprising:
a blocker which blocks incidence of the electromagnetic wave of the predetermined wavelength to the sensor.

2. The image reading device according to claim 1, wherein the electromagnetic wave of the predetermined wavelength is an ultraviolet ray.

3. The image reading device according to claim 1, wherein
the sensor has a photoelectric convertor which light from an image capturing target range enters, the photoelectric convertor being provided on a surface of a substrate, and
the photoelectric convertor is shut inside an optical path area which includes an incident window which light from the image capturing target range passes through.

4. The image reading device according to claim 3, wherein the blocker is provided in the incident window.

5. The image reading device according to claim 3, wherein an antifouling layer is provided on an outer surface of the incident window.

6. The image reading device according to claim 3, wherein a reflection prevention layer of visible light is provided in the incident window.

7. The image reading device according to claim 3, comprising an illuminator which is provided inside the optical path area and lights up the image capturing target range of the sensor through the incident window.

8. The image reading device according to claim 3, comprising a case body accommodating the optical path area and the substrate inside, wherein a heat dissipater to dissipate inner heat is provided in the case body.

9. The image reading device according to claim 8, wherein the heat dissipater includes a ventilation fan, an opening where air outflows and inflows by the ventilation fan, and a filter which blocks outflow and inflow of a dust at the opening.

10. The image reading device according to claim 1, wherein the blocker attenuates an effect of the electromagnetic wave which the irradiator emits for 10 dB or more, with respect to a light receiving sensitivity of a predetermined detecting target wavelength range by the sensor.

11. The image reading device according to claim 1, wherein the sensor performs image capturing of the surface of the recording medium on which the ink that has landed on the recording medium is fixed by the irradiator.

12. An inkjet recording device comprising;
a recorder which discharges an ink onto a recording medium,
the irradiator, and
the image reading device according to claim 1.

13. The inkjet recording device according to claim 12, comprising a conveyer which conveys the recording medium, wherein
an image capturing target range of the sensor is next to an emitting position of the irradiator in the downstream to the emitting position, with respect to a conveyance direction of the recording medium by the conveyer.
